(19) United States
(12) Patent Application Publication
(10) Pub. No.: US 2026/0192651 A1
(43) Pub. Date: Jul. 9, 2026

(54) ACTUATOR MOUNT ARRANGEMENTS FOR ELECTRIC ROLL-OFF REFUSE VEHICLE

(71) Applicant: Oshkosh Corporation, Oshkosh, WI (US)

(72) Inventors: Jeff Verhagen, Oshkosh, WI (US); Aaron Fisher, Oshkosh, WI (US); Greg Steffens, Oshkosh, WI (US)

(73) Assignee: Oshkosh Corporation, Oshkosh, WI (US)

(21) Appl. No.: 19/439,000

(22) Filed: Jan. 2, 2026

Related U.S. Application Data
(60) Provisional application No. 63/741,633, filed on Jan. 3, 2025.
(60) Provisional application No. 63/741,640, filed on Jan. 3, 2025.

(51) Int. Cl. B60K 1/04; B65F 3/08

(52) U.S. Cl. CPC B60K 1/04; B65F 3/08; B60K 2001/0438

(57) ABSTRACT

An electric roll-off vehicle includes a chassis including a frame rail, a cab coupled to a front end of the chassis, an energy storage device coupled to the chassis, and an electric drive motor coupled to the chassis and connected to the energy storage device for driving the electric roll-off vehicle. The electric roll-off vehicle includes a roll-off body assembly coupled to the chassis and positioned behind the cab. The roll-off body assembly includes a roll-off body, and a body actuator configured to raise a front end of the roll-off body. The body actuator is powered by the energy storage device. The body actuator is mounted to an upper surface of the frame rail, and the energy storage device is positioned underneath the roll-off body and on a side of the frame rail, such that the electric energy storage device does not interfere with the body actuator during operation thereof.

### CROSS-REFERENCE TO RELATED APPLICATIONS

This application (a) claims the benefit of and priority to (i) U.S. Provisional Patent Application No. 63/741,640, filed Jan. 3, 2025, and (ii) U.S. Provisional Patent Application No. 63/741,633, filed Jan. 3, 2025, and (b) is related to (i) U.S. patent application Ser. No. ______ (Attorney Docket No. 061300-7309), filed Jan. 2, 2026. The entire contents of each of these applications is hereby incorporated by reference herein.

### BACKGROUND

The present disclosure relates generally to the field of refuse vehicles and, in particular, electrically powered refuse vehicles.

### SUMMARY

One embodiment relates to an electric roll-off vehicle includes a chassis extending a longitudinal length of the electric roll-off vehicle, the chassis comprising at least one frame rail, a cab coupled to a front end of the chassis, an electric energy storage device coupled to the chassis, and an electric drive motor coupled to the chassis and electrically connected to the electric energy storage device for driving the electric roll-off vehicle. The electric roll-off vehicle further includes a roll-off body assembly coupled to the chassis and positioned behind the cab. The roll-off body assembly includes a roll-off body extending at least partially along the longitudinal length of the electric roll-off vehicle, and a body actuator configured to raise a front end of the roll-off body. The body actuator is powered by the electric energy storage device. The body actuator is mounted to an upper surface of the at least one frame rail, and the electric energy storage device is positioned underneath the roll-off body and at least partially on a side of the at least one frame rail, such that the electric energy storage device does not interfere with the body actuator during operation thereof.

In some embodiments, the at least one frame rail includes a first frame rail including a first upper surface and a second frame rail including a second upper surface, where the body actuator is mounted to the first upper surface. In some embodiments, the body actuator is mounted to both the first upper surface and the second upper surface. In some embodiments, the roll-off body assembly further includes a second body actuator configured to raise the front end of the roll-off body, where the second body actuator is mounted to the second upper surface of the second frame rail. The second body actuator is powered by the energy storage device.

In some embodiments, the roll-off body assembly includes an electric motor movably coupled to the body actuator, where the electric motor is electrically coupled to the electric energy storage device.

In some embodiments, the roll-off body is pivotably coupled to the chassis at a pivot point proximate a rear end of the chassis, with the body actuator configured to move the roll-off body assembly from a first position to a second position. In the first position, the roll-off body is substantially parallel to the chassis. In the second position, the roll-off body is angled relative to the chassis, such that the front end of the roll-off body is raised.

In some embodiments, the electric roll-off vehicle further includes a winch assembly configured to pull a refuse container onto the roll-off body when the roll-off body assembly is in the second position. In some embodiments, the winch assembly includes a winch motor and a cable engaged with the winch motor, where the winch motor is electrically coupled to the electric energy storage device.

Another embodiment relates to an electric roll-off vehicle including a chassis extending a longitudinal length of the electric roll-off vehicle, a cab coupled to a front end of the chassis, an energy storage device coupled to the chassis, an electric drive motor coupled to the chassis and electrically connected to the energy storage device for driving the electric roll-off vehicle, and a roll-off body assembly coupled to the chassis and positioned behind the cab. The roll-off body assembly includes a roll-off body extending at least partially along the longitudinal length of the electric roll-off vehicle, and a body actuator configured to raise a front end of the roll-off body. The body actuator is mounted to the chassis between the cab and the energy storage device. The body actuator is powered by the energy storage device

In some embodiments, the chassis includes at least one frame rail, where the body actuator is mounted to a side surface of the at least one frame rail. In some embodiments, the chassis includes a first frame rail including a first side surface and a second frame rail including a second side surface. The body actuator is mounted to the first side surface. In some embodiments, the roll-off body assembly further includes a second body actuator configured to raise the front end of the roll-off body. The second body actuator is mounted to the second side surface of the second frame rail. The second body actuator is powered by the energy storage device.

In some embodiments, the roll-off body is pivotably coupled to the chassis at a pivot point proximate a rear end of the chassis, the body actuator configured to move the roll-off body assembly from a first position to a second position. In the first position, the roll-off body is substantially parallel to the chassis. In the second position, the roll-off body is angled relative to the chassis, such that the front end of the roll-off body is raised. In some embodiments, the electric roll-off vehicle further includes a winch assembly configured to pull a refuse container onto the roll-off body when the roll-off body assembly is in the second position. The winch assembly electrically coupled to the energy storage device.

Another embodiment relates to an electric roll-off vehicle including a chassis supporting a plurality of tractive elements, where the chassis includes a lower frame rail, and an upper frame rail coupled to and positioned above the lower frame rail. The electric roll-off vehicle includes a cab coupled to a front end of the chassis, an energy storage device coupled to the chassis, where the energy storage device extends between the upper frame rail and the lower frame rail, an electric drive motor coupled to the chassis and electrically connected to the energy storage device for powering movement of the tractive elements, and a roll-off body assembly coupled to the upper frame rail of the chassis and positioned behind the cab and above the energy storage device. The roll-off body assembly includes a roll-off body extending at least partially along a longitudinal length of the electric roll-off vehicle, and a body actuator configured to raise a front end of the roll-off body. The body actuator is mounted to the upper frame rail. The body actuator is powered by the energy storage device.

In some embodiments, the lower frame rail is positioned partially below the energy storage device and the upper frame rail is positioned partially above the energy storage device. In some embodiments, the body actuator is mounted to a side portion of the upper frame rail. In some embodiments, the body actuator is mounted to the side portion of the upper frame rail between the cab and the energy storage device.

In some embodiments, the upper frame rail is a first upper frame rail, and the lower frame rail is a first lower frame rail. The chassis further includes a second lower frame rail, and a second upper frame rail coupled to and positioned above the second lower frame rail. The roll-off body assembly further includes a second body actuator configured to raise the front end of the roll-off body, with the second body actuator mounted on the second upper frame rail. The second body actuator is powered by the energy storage device. In some embodiments, the chassis further includes a support member coupled to the upper frame rail and configured to position the roll-off body assembly above the energy storage device.

### BRIEF DESCRIPTION OF THE DRAWINGS

FIG. 1 is a left side view of a vehicle, according to an exemplary embodiment.

FIG. 2 is a perspective view of a chassis of the vehicle of FIG. 1.

FIG. 3 is a side view of an electric roll-off vehicle including a roll-off body in a first position, according to an exemplary embodiment.

FIG. 4 is a side view of the electric roll-off vehicle including the roll-off body in a second position, according to an exemplary embodiment.

FIG. 5 is a side view of an electric roll-off vehicle including a tarp cover assembly, according to an exemplary embodiment.

FIG. 6 is a side view of the electric roll-off vehicle including the tarp cover assembly, according to another exemplary embodiment.

FIG. 7 is a top view of an electric roll-off vehicle, according to an exemplary embodiment.

FIG. 8 is a side view of an electric roll-off vehicle, according to an exemplary embodiment.

FIG. 9 is a section view of the electric roll-off vehicle of FIG. 8 taken normal to a longitudinal axis of the electric roll-off vehicle, according to an exemplary embodiment.

FIG. 10 is a method for assembling an electric roll-off vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Embodiments of the present disclosure relate generally to actuator arrangements for an electric roll-off refuse vehicle for conveying commercial containers between a residence or place of business to a landfill or other transfer station or processing facility. The vehicle may include a roll-off body assembly that includes actuators to power movement of a platform for supporting the container onboard the vehicle chassis, and to move the container relative to the platform and vehicle chassis during loading/unloading operations. In some embodiments, the roll-off body assembly may be supported by a reconfigurable electric chassis that may also be used to power operation of alternative types of refuse vehicle loading arrangements.

According to an exemplary embodiment, the roll-off body assembly includes actuators and actuator mounts along the chassis that are structured to reduce the overall space claim of the roll-off body assembly. The actuator and actuator mounts are structured to enable seamless integration with components of the electric energy system for the electric roll-off vehicle. For example, the actuator arrangements provide for the roll-off body actuator(s) to operate without interference from the electrical energy system components (e.g., battery packs and/or a housing thereof, etc.). The actuator arrangements provide for the electric roll-off vehicle to be operable without separate structures (e.g., housings) for the actuator onboard the vehicle (e.g., at the rear-end thereof, etc.). Such implementations, as described in further detail below, can reduce the overall footprint of the electric roll-off vehicle, while improving system operating efficiency and enabling the use of clean, renewable energy sources to power operation of the roll-off refuse vehicle.

### Overall Vehicle

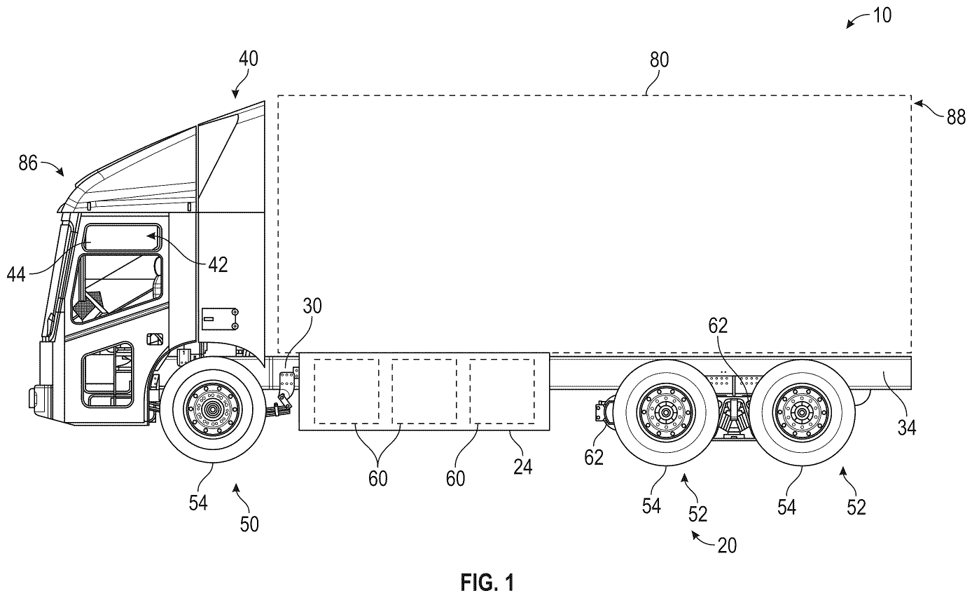

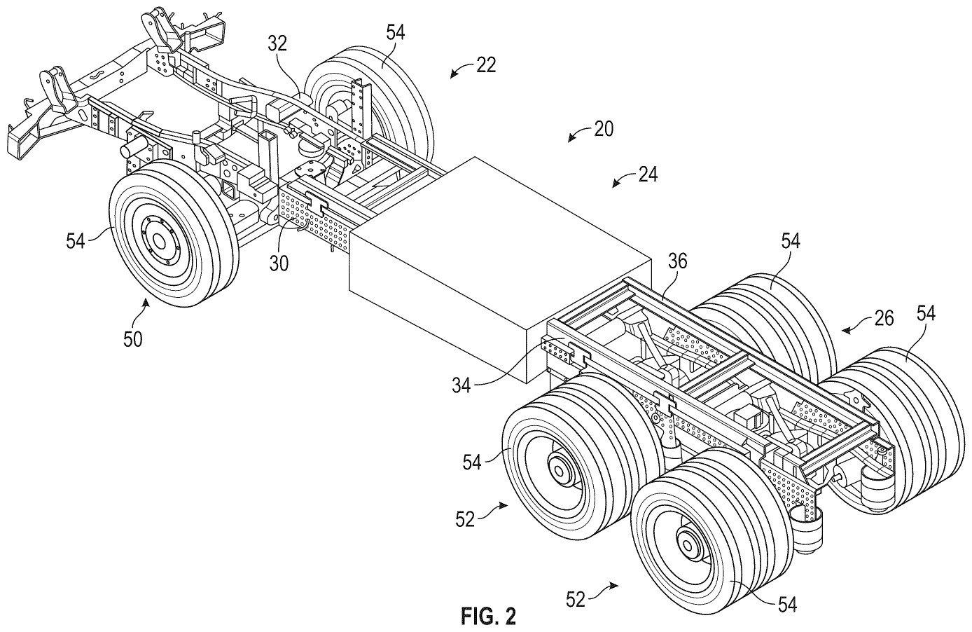

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles 52 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10 (e.g., within or adjacent to the front section 22 and/or the rear section 26). The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 54 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the axle front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, such as a roll-off refuse vehicle as will be further described herein, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. In some embodiments, the reconfigurable vehicle cab 40 and chassis 20 may have a similar structure as described in U.S. application Ser. No. 19/004,153, filed Dec. 27, 2024, the entire contents of which are hereby incorporated by reference herein.

Although the application kit 80 is described as a separate assembly from the remainder of the vehicle 10 (e.g., from the chassis 20, from the cab 40, etc.) and in the context of a reconfigurable vehicle, it should be understood that in other embodiments the application kit 80 is a dedicated body, implement, etc. that is configured to be fixedly mounted to the vehicle 10 (e.g., to different parts of the vehicle 10, or forming portions of the vehicle 10).

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

### All-Electric Roll-Off Vehicle

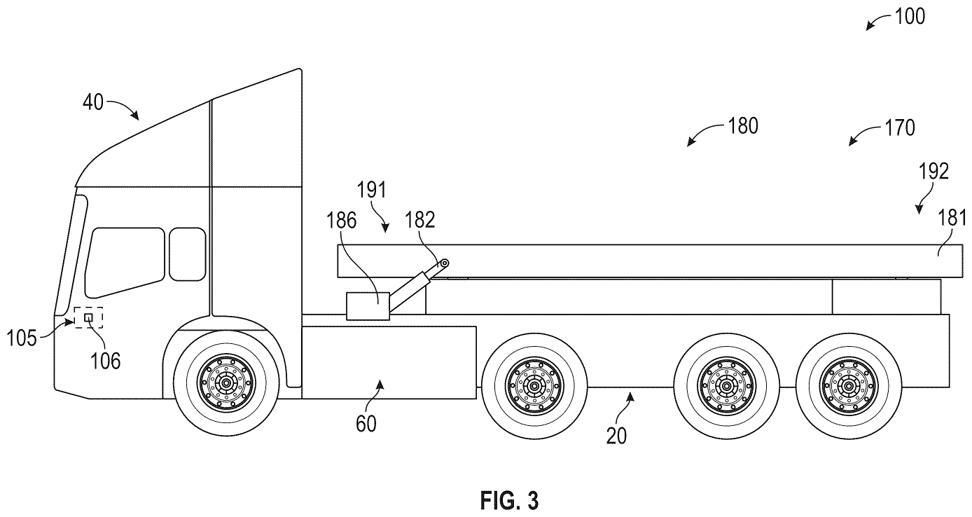

Referring to FIG. 3, a vehicle configured as an electric roll-off vehicle 100 that is propelled by an electric powertrain system is shown, according to an embodiment. The electric roll-off vehicle 100 includes a chassis 20 extending a longitudinal length of the vehicle and a cab 40 coupled to a front end of the chassis 20.

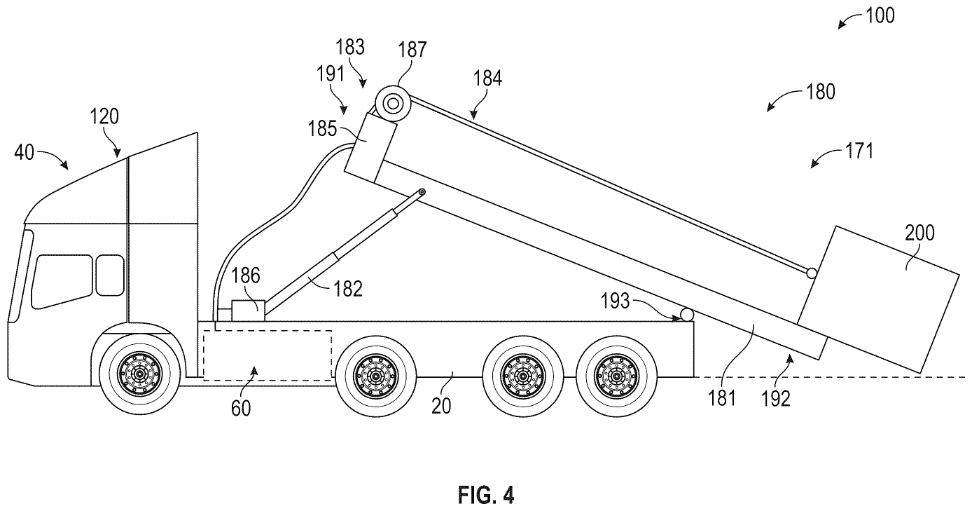

Referring to FIGS. 1-4, the electric roll-off vehicle 100 includes one or more electric energy storage devices coupled to the chassis and one or more prime movers coupled to the chassis and electrically connected to the electric energy storage device for driving the electric roll-off vehicle. The one or more electrical energy storage devices (e.g., batteries, capacitors, etc.) are shown as batteries 60. In some embodiments, the batteries 60 are positioned within the middle section 24 of the chassis 20 as described with reference to FIGS. 1 and 2. The one or more prime movers includes one or more electromagnetic devices (e.g., motor/generators), shown as drive motors 62. The drive motors 62 are electrically coupled to the batteries 60. The drive motors 62 are configured to receive electrical energy from the batteries 60 and provide rotational mechanical energy to the wheel and tire assemblies 54 to propel the vehicle 10. The electric roll-off vehicle 100 further includes the application kit 80 (see FIG. 1) configured as a roll-off body assembly 180. In some embodiments, the electric roll-off vehicle 100 further includes a cowl assembly 120 (e.g., a cowl assembly 120 above the cab as shown in FIG. 4 for storing cooling equipment and/or other components of the electric energy system and/or the actuator system).

### A. Roll-Off Body Assembly

Referring to FIGS. 3 and 4, the electric roll-off vehicle 100 includes the roll-off body assembly 180. The roll-off body assembly 180 is coupled to the chassis 20. The roll-off body assembly 180 includes a roll-off body 181 extending a longitudinal length of the electric roll-off vehicle 100. For example, the roll-off body 181 may be a flat platform for supporting an object 200, which may include a commercial refuse container (e.g., a 10-yard container, a 20-yard container, a 30-yard container, a 40-yard container, or larger). The roll-off body assembly 180 further includes one or more body actuators, shown as body actuator 182, configured to raise a front end 191 of the roll-off body 181 and to pivot the roll-off body 181 relative to the chassis between a first, transit position, in which the roll-off body 181 extends along the longitudinal direction (see FIG. 3) and a second, bin collection position, in which the roll-off body 181 is angled with respect to the chassis (see FIG. 4). The roll-off body 181 may include a rear end 192 configured to rest on a ground surface for the object 200 to be slid onto the roll-off body 181 when the body actuator 182 raises the front end 191 of the roll-off body 181 (e.g., in the second position).

For example, the rear end 192 of the roll-off body 181 may be lowered (e.g., toward the ground surface) when the body actuator 182 raises the front end 191 of the roll-off body 181. The roll-off body assembly 180 further includes a container lift assembly, shown as winch assembly 183, including a cable 184 and a lift motor, shown as winch motor 185. The winch assembly 183 is configured to pull the object 200 onto the roll-off body 181.

During a collection operation, the body actuator 182 raises the front end 191 of the roll-off body 181, moving the roll-off body 181 from the first position to the second position, and so that the rear end 192 of the roll-off body 181 engages or is positioned adjacent to the ground surface. After moving the roll-off body 181, the cable 184 is attached to the object 200, and the winch motor 185 is activated to pull the object 200 onto the roll-off body 181. After lifting the object 200 onto the roll-off body 181, the body actuator 182 moves the roll-off body 181 from the second position back to the first position, lowering the front end 191 of the roll-off body 181 into a substantially level position for stably supporting the object 200 on the roll-off body 181 during transit of the electric roll-off vehicle 100.

In other embodiments, the roll-off body 181 may include another form of container lift assembly, actuator, or system in place of, or in combination with, the winch assembly 183. For example, the roll-off body 181 may include a retractable/extendible lift arm including a hook or another container engaging member to facilitate loading of the object 200 onto the roll-off body 181.

Referring still to FIGS. 3 and 4, the roll-off body 181 is configured to support the object 200 when the object 200 is loaded onto the roll-off body 181. The roll-off body 181 extends at least partially along the longitudinal length of the electric roll-off vehicle 100 (e.g., extends down the frame rails behind the cab 40). The roll-off body 181 may be or include the flat platform (e.g., a flatbed). The roll-off body 181 may be supported by the chassis 20 of the electric roll-off vehicle 100, such as directly on the chassis 20 or on an intermediate support between the chassis 20 and the platform.

The roll-off body 181 may be coupled to the chassis 20, such as at a pivot point 193 disposed at (e.g., proximate) a rear end of the chassis 20. In some embodiments, the roll-off body 181 may be a support rail for the object 200 to be loaded onto the electric roll-off vehicle 100 with the object 200 resting on the frame rails (e.g., the first frame rail and the second frame rail) and the support rail (e.g., on top surfaces of the rails). In some embodiments, the roll-off body 181 may be configured to correspond to a bottom of the object 200. For example, the roll-off body 181 may be the support rail configured to mate with a corresponding rail and/or track on the bottom of the object 200 for loading onto the roll-off body 181.

In some embodiments, the roll-off body assembly 180 is coupled to the chassis 20. The roll-off body assembly 180 may be coupled to the chassis 20 at multiple points. The roll-off body assembly 180 may be coupled to the chassis 20 near the front end 191 of the roll-off body 181, where the body actuator 182 is coupled to both the chassis 20 and the roll-off body 181 for lifting the roll-off body 181(e.g., raising the roll-off body 181 to load and/or unload the object 200). The roll-off body assembly 180 may also be connected to (e.g., pivotally coupled to) the chassis 20 at the pivot point 193 near the rear end 192 of the roll-off body assembly 180. The pivot point 193 is configured to anchor the roll-off body assembly 180 to the chassis 20 while the front end 191 of the roll-off body 181 is raised and/or lowered by the body actuator 182. For example, the pivot point 193 defines where the roll-off body 181 is configured for the rear end 192 of the roll-off body assembly 180 to be lowered when the front end 191 is raised by the body actuator 182. The pivot point 193 may define the ends of the roll-off body 181. For example, the front end 191 of the roll-off body 181 may be defined as a portion of the roll-off body 181 between the pivot point 193 and the cab 40 of the electric roll-off vehicle 100, while the rear end 192 of the roll-off body 181 may be defined as a portion of the roll-off body 181 between the pivot point 193 and a rear end of the electric roll-off vehicle 100 (e.g., where the rear end of the electric roll-off vehicle 100 is the end opposite the front end). In some embodiments, the pivot point 193 is formed by a pivot assembly including a shaft and a mount that rotatably couples the shaft to the chassis 20.

In some embodiments, the body actuator 182 is coupled to the chassis 20. For example, the body actuator 182 may be coupled to one of the frame rails. In some embodiments, the body actuator 182 is coupled to a side of one of the frame rails. In some embodiments, the body actuator 182 is coupled to a top surface of one of the frame rails. In some embodiments, the roll-off body assembly 180 further includes a secondary frame rail (e.g., a subframe of the roll-off body assembly 180 that may couple the roll-off body assembly 180 to the chassis 20). The secondary frame rail may be connected to and positioned above one of the frame rails. The body actuator 182 may couple to the secondary frame rail (e.g., to a side of the secondary frame rail). Other configurations for mounting the body actuator 182 to the chassis 20 may be used for the body actuator 182 to raise and/or lower the roll-off body assembly 180.

In some embodiments, the body actuator 182 is and/or includes an electric actuator powered by an electric motor. In such embodiments, the body actuator 182 is electrically coupled to the batteries 60 of the electric roll-off vehicle 100. For example, the body actuator 182 may include and/or be coupled (e.g., electrically coupled, movably coupled, etc.) to an actuator motor 186 (e.g., the electric motor), electrically coupled to the batteries 60, for operating the body actuator 182. Such an arrangement can improve responsiveness and controllability of the actuator without requiring complex valving or hydraulic manifolds on the vehicle 100. In other embodiments, the body actuator 182 includes a hydraulic actuator powered by an electric-motor-driven hydraulic pump. In some embodiments, components of the actuator system (e.g., the actuator, the motor, and/or the pump) are coupled to (e.g., disposed on, mounted to, or otherwise integrated with) the roll-off body assembly 180. In other embodiments, at least one of the actuator system components is coupled to the chassis 20 or the cab.

In some embodiments, the roll-off body assembly 180 (e.g., a container lift assembly, etc.) includes the winch assembly 183 including a winch body 187, the cable 184, and the winch motor 185. The winch body 187 is configured to engage (e.g., hold) the cable 184 (e.g., the cable 184 may be wrapped around the winch body 187 like a spool). The winch body 187 may be coupled to the chassis 20 of the electric roll-off vehicle 100. The cable 184 is attached to the winch body 187 at an anchoring end of the cable 184. An attachment end of the cable 184 may be attached to the object 200. The winch motor 185 is coupled to the winch body 187 for extending or retracting the cable 184 to pull the object 200 onto or off of the roll-off body 181. The winch motor 185 is electrically coupled to the batteries 60 of the electric roll-off vehicle 100. A container lift assembly disconnect (e.g., a winch disconnect) may be included between the winch motor 185 and the batteries 60 for selectively decoupling the winch assembly 183 from the electric roll-off vehicle 100 when the winch assembly 183 is not in use (e.g., for pulling the object). In some embodiments, the disconnect may be positioned between all electric actuators for the roll-off body assembly 180 and the batteries. In some embodiments, the hydraulic pumps, electric motors, power converter(s), and/or the disconnect may form part of an electric power take off (EPTO) system, as will be further described. Other configurations of the winch assembly 183 may be used.

In some embodiments, and as described above, the roll-off body assembly 180 is configured in a first position 170 (e.g., a level position, a transit position), where the roll-off body 181 is positioned substantially parallel to the chassis 20 of the electric roll-off vehicle 100. In the first position 170, the roll-off body 181 may be positioned substantially parallel to the ground. In the first position 170, the body actuator 182 is in a retracted position. In some embodiments, the object 200 is supported on the roll-off body 181 when the roll-off body assembly 180 is in the first position 170 for transporting the object 200 using the electric roll-off vehicle 100.

In some embodiments, the roll-off body assembly 180 is configured in a second position 171 (e.g., a roll-off position, a loading position, an angled position), where the roll-off body 181 is positioned angled to the chassis 20 of the electric roll-off vehicle 100. In the second position 171, the roll-off body 181 may be positioned angled to the ground. In the second position 171, the body actuator 182 is in an extended position. In some embodiments, the object 200 is unloaded and/or loaded (e.g., rolled-off/on) the roll-off body 181 when the roll-off body assembly 180 is in the second position 171. In some embodiments, the electric roll-off vehicle 100 used the body actuator 182 to move the roll-off body assembly 180 from the first position 170 to the second position 171. The body actuator 182 extends to raise the front end 191 of the roll-off body 181 and lower the rear end 192 of the roll-off body 181.

In some embodiments, the electric roll-off vehicle 100 includes the roll-off body assembly 180 configured in the first position 170, without the object 200, while the electric roll-off vehicle 100 is in transit from a first location (e.g., a parking area, a vehicle station). When the electric roll-off vehicle 100 arrives at a second location (e.g., at the object) to load the object 200 onto the electric roll-off vehicle 100, the body actuator 182 extends to move the roll-off body assembly 180 into the second position 171. The body actuator 182 raises the front end 191 of the roll-off body 181 and lowers the rear end 192 of the roll-off body 181 near the object 200 for loading the object 200 onto the roll-off body 181. The cable 184 of the winch assembly 183 is extended (e.g., by an operator) and attached to the object 200. The cable 184 may be extended and attached before the body actuator 182 raises the roll-off body 181. The winch motor 185 pulls the object 200 onto the roll-off body 181 by retracting the cable 184. The body actuator 182 retracts to lower the front end 191 of the roll-off body 181 and raise the rear end 192 of the roll-off body 181. The body actuator 182 may retract once the object 200 is loaded onto the roll-off body 181 using the winch assembly 183. The body actuator 182 may retract simultaneously to the object 200 being loaded onto the roll-off body 181 (e.g., retracting the body actuator 182 may help the winch motor 185 load the object 200). The body actuator 182 retracting configures the roll-off body assembly 180 back into the first position 170, with the object 200 loaded onto the roll-off body 181. The electric roll-off vehicle 100 may transport the object 200 to a third location with the roll-off body assembly 180 in the first position 170.

In some embodiments, the electric roll-off vehicle 100 may unload the object 200 from the roll-off body 181 at an unloading location (e.g., the second location, the third location). The roll-off body assembly 180 is configured in the first position 170, with the object 200 loaded onto the roll-off body 181, until the electric roll-off vehicle 100 arrives at the second location. At the second location, the body actuator 182 moves the roll-off body assembly 180 (e.g., the platform) into the second position 171 for unloading the object 200. The cable 184 may be attached to the object 200, and the winch motor 185 may extend the cable 184 (e.g., give slack) for controlling motion of the object 200 during unloading. In the second position, the gravitational force acting on the object 200 may cause the object 200 to roll (e.g., slide) off the roll-off body 181and onto the ground surface. Once the object 200 is unloaded, the body actuator 182 retracts to return the roll-off body assembly 180 to the first position 170 for the electric roll-off vehicle 100 to drive to another location.

In some embodiments, the object 200 is a refuse container. For example, the electric roll-off vehicle 100 may be used to collect the refuse container when the refuse container is full of refuse for discarding the refuse. The electric roll-off vehicle 100 may drive from the first location (e.g., parking spot, charging station) to the second location (e.g., a worksite, office building), where the refuse container is positioned to be filled with refuse. The electric roll-off vehicle 100 may then drive to a third location (e.g., a central refuse collection area, a transfer station, a landfill) to deposit the refuse collected in the refuse container. The electric roll-off vehicle 100 may then drive back to the second location to return the refuse container for refuse collection. The electric roll-off vehicle 100 promotes environmentally beneficial refuse collection practices by enabling the use of renewable energy sources (e.g., wind, solar, etc.) in the collection of large refuse containers.

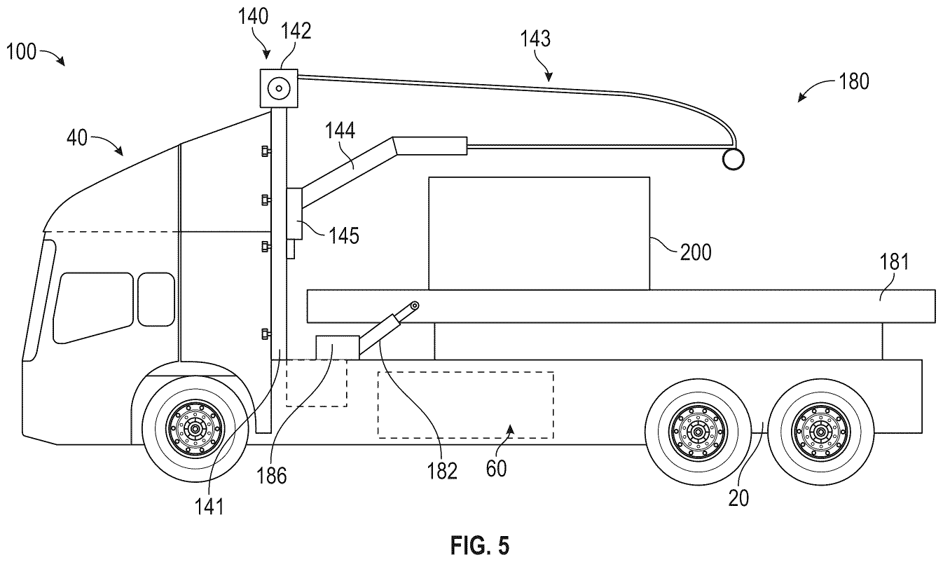

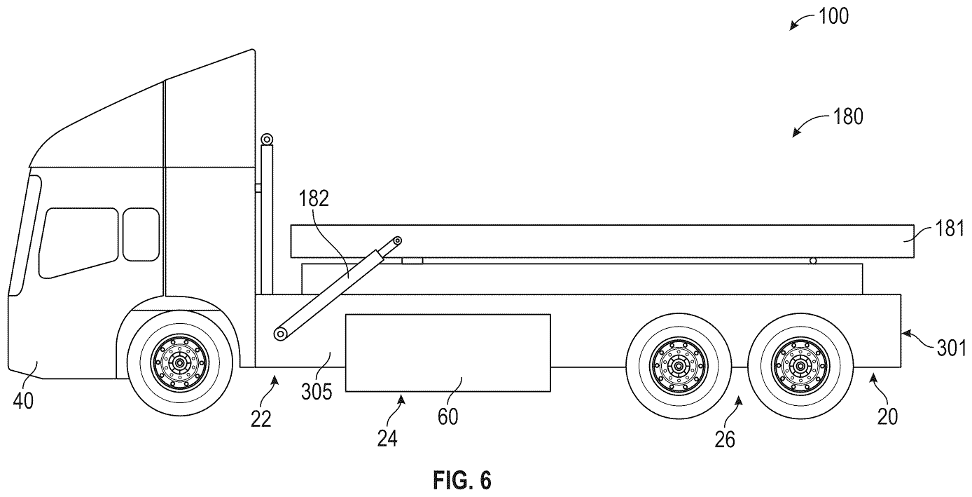

Referring to FIGS. 5 and 6, the roll-off body assembly 180 of the electric roll-off vehicle 100 further includes a tarp cover assembly 140. The tarp cover assembly 140 is coupled to the chassis 20 of the electric roll-off vehicle 100. In some embodiments, the tarp cover assembly 140 includes a frame, further including one or more support columns, shown as support column 141. In some embodiments, and as shown, the frame of the tarp cover assembly 140 is coupled to the chassis 20. In other embodiments, the tarp cover assembly 140 may be coupled to a subframe or other components of the roll-off body assembly 180. The tarp cover assembly 140 further includes a tarp cover body 142, configured to store a tarp 143 for covering the object 200 loaded onto the roll-off body 181 (e.g., the tarp 143 may be wound around the tarp cover body 142 like a spool). The tarp cover body 142 is positioned at a first end of the support column 141. The tarp cover body 142 may include a housing to protect (e.g., from rain, snow, etc.) the tarp 143 when stored using the tarp cover body 142.

The tarp cover assembly 140 further includes one or more tarp cover actuators, shown as tarp cover actuator 144, configured to extend the tarp 143 from the tarp cover body 142 over the object 200 loaded onto the roll-off body 181 (e.g., extend the tarp 143 toward the rear end of the electric roll-off vehicle 100). A first end of the tarp cover actuator 144 is coupled to the tarp 143. A second end of the tarp cover actuator 144 is coupled to the chassis 20 of the electric roll-off vehicle 100. For example, the tarp cover actuator 144 may be coupled to one of the frame rails (e.g., to a top surface of one of the frame rails, a side surface of one of the frame rails, etc.). In some embodiments, a second tarp cover actuator may be configured similarly to the tarp cover actuator 144 on an opposite side of the roll-off body assembly 180.

The tarp cover assembly 140 further includes a tarp cover motor 145 configured to operate the tarp cover actuator 144 for covering the object 200 loaded onto the roll-off body 181. The tarp cover motor 145 may be an electric motor. In some embodiments, the tarp cover assembly 140 may be electrically coupled to the batteries 60 of the electric roll-off vehicle 100. For example, the tarp cover motor 145 may be electrically coupled with the batteries 60 for operating the tarp cover assembly 140. The tarp cover assembly 140 may be configured to be operated by an operator of the electric roll-off vehicle 100 (e.g., via a controller based on inputs from a user interface within the cab 40 or alongside the vehicle 100).

In some embodiments, the tarp cover assembly 140 is configured where the support column 141 positions the tarp cover body 142 at a height above the object 200 loaded onto the roll-off body 181. For example, the tarp cover body 142 may be positioned at a height corresponding to a rear shroud 122 (e.g., a guard, a cowl) behind a cab 40 of the vehicle 100 that is used to store one or more system components of the vehicle 100 (e.g., the electric motors, the hydraulic pump, the power converter(s), the disconnect, etc.). In some embodiments, the tarp cover body 142 is positioned at a height below the rear shroud 122. In some embodiments, the tarp cover body 142 is positioned at a height above the rear shroud 122. The tarp cover body 142 may be positioned at a height above the cab 40 of the electric roll-off vehicle 100. For example, the tarp cover assembly 140 may extend above the cab 40.

Referring to FIGS. 1 through 6, the roll-off body assembly 180 and/or components thereof (e.g., the winch assembly 183, the tarp cover assembly 140, the body actuator 182, etc.) are communicably coupled to a control system 105 of the electric roll-off vehicle 100. The control system 105 may include a controller 106 in communication with a control panel (e.g., user interface, user controller, inputs, etc.). The control panel may include one or more user interfaces (e.g., buttons, levers, joysticks, knobs, LCD displays, touch displays, etc.) that, when interacted with (e.g., pressed, touched, engaged, etc.) by an operator of the electric roll-off vehicle 100, transmits a signal to the controller 106 to command one or more components of the roll-off body assembly 180 (e.g., the winch motor 185, the body actuator 182, the actuator motor 186) to perform an action. Each panel button included in the control panel may be associated with a different action and/or operation of the one or more components of the roll-off body assembly 180. In other embodiments, multiple actions may be performed using a single user interface component (e.g., a joystick, etc.).

The controller 106 may include a processing circuit having a processor and memory. The processing circuit can be communicably connected to a communications interface such that the processing circuit and the various components thereof can send and receive data via the communications interface. The processor can be implemented as a general purpose processor, an application specific integrated circuit (“ASIC”), one or more field programmable gate arrays (“FPGAs”), a group of processing components, or other suitable electronic processing components. The memory (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory can be or include volatile memory or non-volatile memory. The memory can include database components, object code components, script components, or any other type of information structure for supporting the various activities and information structures described in the present application. According to some embodiments, the memory is communicably connected to the processor via the processing circuit and includes computer code for executing (e.g., by the processing circuit and/or the processor) one or more processes described herein.

### B. Actuator Mounting Arrangement for the Roll-Off Body Assembly

Referring to FIGS. 1-7, the electric roll-off vehicle 100 includes the chassis 20 extending a longitudinal length of the electric roll-off vehicle 100 (see FIG. 2). The roll-off body assembly 180 includes the body actuator 182 configured to raise and/or lower the roll-off body 181. The body actuator 182 is mounted to the chassis 20. The body actuator 182 includes an actuator motor 186, electrically coupled to the batteries 60, for operating the body actuator 182 (e.g., to raise or lower the roll-off body 181). The actuator motor 186 may be mounted to the chassis 20. In some embodiments, the body actuator 182 may include a mounting portion 320 (e.g., a mounting bracket) configured to mount the body actuator 182 onto the chassis 20.

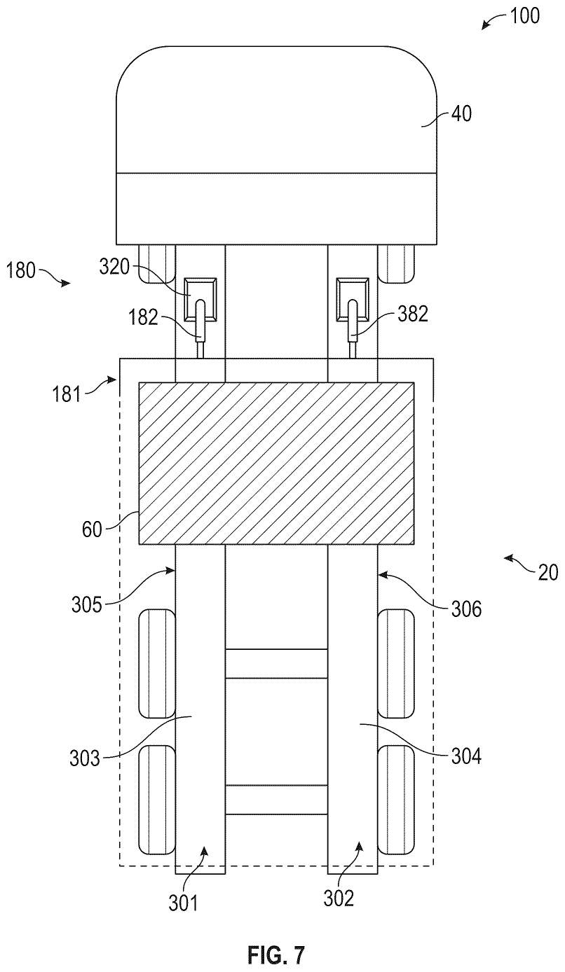

Referring to FIGS. 2 and 7, the chassis 20 includes at least one frame rail. The at least one frame rail may include a first frame rail 301. The at least one frame rail may include a second frame rail 302. The first frame rail 301 and the second frame rail 302 may be similarly configured. The at least one frame rail may include additional frame rails (e.g., a third frame rail). In some embodiments, the first frame rail 301 and/or the second frame rail 302 may be continuous frame rails extending a longitudinal length of the electric roll-off vehicle 100. For example, the front section 22, the middle section 24, and the rear section 26 of the chassis 20 may be defined by the first frame rail 301 and the second frame rail 302 extending continuously along the longitudinal length of the electric roll-off vehicle 100. As shown in FIG. 2, the front rail portion 30 and the rear rail portion 34 would be front and rear portions of the first frame rail 301, and the front rail portion 32 and the rear rail portion 36 would be front and rear portions of the second frame rail 302. The middle section 24 may include a center portion of the first frame rail 301 and/or the second frame rail 302.

In some embodiments, the front section 22 includes the front rail portion 30 and the front rail portion 32. The rear section 26 includes the rear rail portion 34 and the rear rail portion 36. The front section 22 and the rear section 26 are configured as separate, discrete subframes (e.g., a front subframe and a rear subframe). The front rail portion 30, the front rail portion 32, the rear rail portion 34, and the rear rail portion 36 are separate, discrete frame rails that are spaced apart from one another. In some embodiments, the first frame rail 301 may include the front rail portion 30 and/or the rear rail portion 34. The second frame rail 302 may include the front rail portion 32 and/or the real rail portion 36. In some embodiments, the first frame rail 301 may include both the front rail portion 30 and the rear rail portion 34. The second frame rail 302 may include both the front rail portion 32 and the rear rail portion 36.

In some embodiments, and as shown in FIGS. 3-7, the body actuator 182 is mounted to an upper surface of the at least one frame rail. The body actuator 182 may be mounted to an upper surface 303 (e.g., a first upper surface) of the first frame rail 301. The body actuator 182 may be mounted to an upper surface 304 (e.g., a second upper surface) of the second frame rail 302. For example, the chassis 20 may include the first frame rail 301 and the upper surface 303 thereof, and the second frame rail 302 and the upper surface 304 thereof, where the body actuator 182 is mounted to both the upper surface 303 of the first frame rail 301 and the upper surface 304 of the second frame rail 302.

The body actuator 182 may be mounted onto the chassis 20 (e.g., onto the at least one frame rail) using fasteners (e.g., bolted onto the chassis 20). The body actuator 182 may be mounted to the upper surface 303 of the first frame rail 301 and/or the upper surface 304 of the second frame rail 302 when the frame rails are configured according to various embodiments, as described herein. For example, the body actuator 182 may be mounted to the upper surface 303 of the first frame rail 301 where the upper surface 303 is an upper surface of the front rail portion 30 and/or the rear rail portion 34. The body actuator 182 may be mounted to the upper surface 304 of the second frame rail 302 where the upper surface 304 is an upper surface of the front rail portion 32 and/or the rear rail portion 36.

In some embodiments, the roll-off body assembly 180 includes a second body actuator 382, which may be the same as or similar to the body actuator 182. The second body actuator 382 is mounted to the roll-off body 181. The second body actuator 382 is mounted to the chassis 20. The second body actuator 382 may be positioned parallel to the body actuator 182. For example, the body actuator 182 may be mounted to the upper surface 303 of the first frame rail 301, and the second body actuator 382 may be mounted to the upper surface 304 of the second frame rail 302. The body actuator 182 and the second body actuator 382 may be configured to operate in unison to raise and/or lower the roll-off body 181.

Beneficially, mounting the body actuator 182 to the upper surfaces of the frame rails can avoid interference with the batteries 60 of the electric roll-off vehicle 100, which may be mounted along the sides and/or in between the frame rails of the chassis 20. For example, the batteries 60 may be stored in the middle section 24 of the chassis 20, and may extend laterally away from the sides of the chassis 20, where it may be difficult to mount the body actuator 182 on sides of the frame rails without interfering with the batteries 60 (e.g., colliding with the batteries 60 during operation of the body actuator 182).

Referring to FIG. 6, in some embodiments, the body actuator 182 is coupled to a side of one of the frame rails. The body actuator 182 may be coupled to a side 305 of the first frame rail 301. In some embodiments, the body actuator 182 may be coupled to a side 306 of the second frame rail 302. The side 305 and/or the side 306 may be an inner side (e.g., facing within the chassis 20) or an outer side (e.g., facing the street, facing externally to the chassis 20) of the frame rails. The body actuator 182 may be mounted to one of the sides of the frame rails using fasteners (e.g., bolts). In other embodiments, the body actuator 182 may be welded or otherwise permanently affixed to the chassis 20. The body actuator 182 may include the mounting portion 320 mounted to one of the sides of the frame rails.

Referring to FIG. 6, the body actuator 182 is mounted to the chassis 20 between the cab 40 and the plurality of batteries 60. The body actuator 182 may be mounted to the first frame rail 301 between the cab 40 and the plurality of batteries 60. The body actuator 182 may be mounted to the side 305 of the first frame rail 301 between the cab 40 and the plurality of batteries 60. In some embodiments, the body actuator 182 may be mounted to the first frame rail 301 within the front section 22 of the chassis 20 (e.g., the front rail portion 30). For example, the side 305 of the first frame rail 301 may be positioned within the front rail portion 30 of the first frame rail 301. The batteries 60 may be stored in the middle section 24 of the chassis 20. In some embodiments, the batteries 60 may be mounted to the chassis 20 at the middle section 24. Mounting the body actuator 182 to the side 305 of the first frame rail 301 may provide for other components of the vehicle 10 to be mounted underneath and/or between the frame rails (e.g., where a body actuator may be traditionally mounted, etc.). Furthermore and/or in addition to, mounting the body actuator 182 to the side 305 of the first frame rail 301 may simplify routing of electrical cables and/or other conduits to the body actuator 182.

In some embodiments, the chassis 20 may be configured with the front section 22 extended as compared to the chassis 20 as depicted in FIG. 2. The rear section 26 may be shortened when compared to the chassis 20 as depicted in FIG. 2. The middle section 24 may be positioned closer to the rear end of the electric roll-off vehicle 100. In other words, the middle section 24, including the batteries 60 if positioned and/or coupled at the middle section 24, may be positioned nearer to the rear end of the electric roll-off vehicle 100 as compared to the middle section 24 as depicted in FIG. 2.

Configuring the chassis 20 with the front section 22 elongated and the rear section 26 shortened, as compared to the chassis 20 of FIG. 2, can reduce the risk of interference between the body actuator 182 and the batteries 60 of the electric roll-off vehicle 100. For example, when the batteries 60 are stored within and/or coupled to the middle section 24 of the chassis 20, it may be difficult to mount the body actuator 182 on sides of the frame rails within the front section 22 of the chassis 20 without interfering with the batteries 60 (e.g., colliding with the batteries 60 during operation of the body actuator 182). In some embodiments, the body actuator 182 may be configured where mounting the body actuator 182 to the sides of the frame rails does not interfere with the batteries 60 when the chassis 20 is configured as depicted in FIG. 2.

In some embodiments, where the roll-off body assembly 180 includes the body actuator 182 and the second body actuator 382, the body actuator 182 may be mounted to the side 305 of the first frame rail 301 and the second body actuator 382 may be mounted to the side 306 of the second frame rail 302. A controller onboard the vehicle may be configured to coordinate operation of the body actuator 182 and the second body actuator 382 to raise and/or lower the roll-off body 181, and to provide a uniform lift force and height during operation. The second body actuator 382 may be mounted according to an embodiment of the body actuator 182 mounted to the frame rails, as described herein.

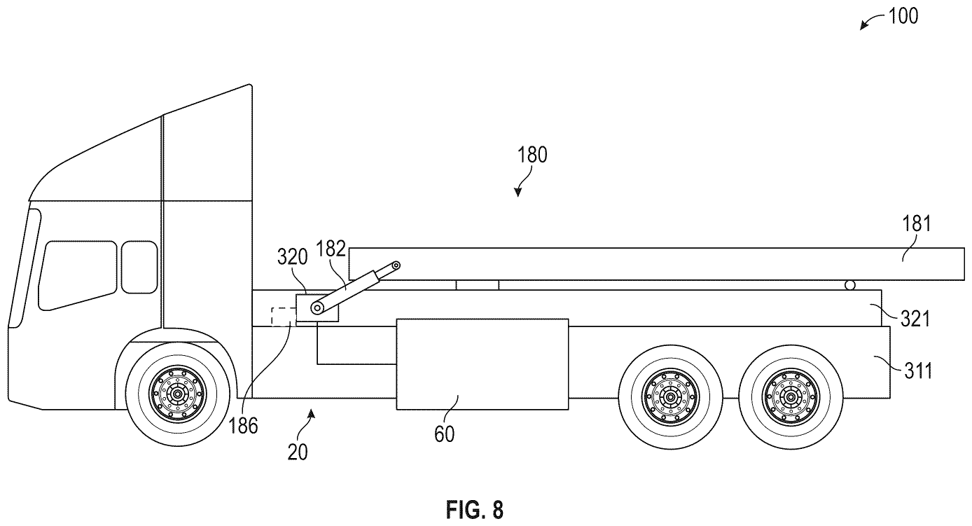

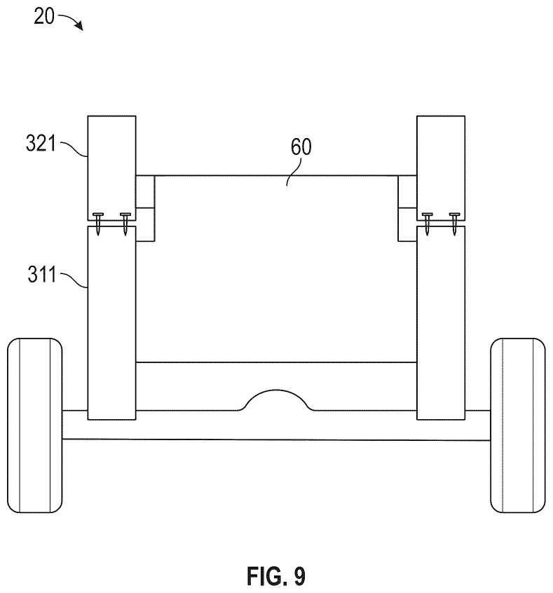

Referring to FIGS. 8 and 9, in some embodiments, the electric roll-off vehicle 100 (e.g., the roll-off body assembly) includes a sub-frame that is configured to support a platform of the roll-off body assembly above the chassis 20. The sub-frame may also provide greater space to accommodate at least a portion of the energy storage device, or other power system components. Thereby, the body actuator 182 may be spaced apart from the batteries 60, such that interference between the batteries 60 and the body actuator 182 is reduced during operation of the body actuator 182 (e.g., to raise or lower the roll-off body 181, etc.).

As shown in FIGS. 8 and 9, the electric roll-off vehicle 100 includes the chassis 20 including a lower frame rail 311 and the sub-frame, shown as upper frame rail 321. The upper frame rail 321 is positioned above and coupled to the lower frame rail 311.

In some embodiments, the lower frame rail 311 may be the first frame rail 301. For example, the lower frame rail 311 may include a front lower rail portion and/or a rear lower rail portion, similar to the front rail portion 30 and/or the rear rail portion 34 of the first frame rail 301. In some embodiments, the upper frame rail 321 may be configured similarly to the lower frame rail 311. For example, the upper frame rail 321 may include a front upper rail portion and/or a rear upper rail portion, similar to the front rail portion 30 and/or the rear rail portion 34 of the first frame rail 301. The chassis 20 including the lower frame rail 311 and the upper frame rail 321 may include the frame rails as separate, discrete subframes and/or continuous frame rails, similar to various embodiments of the chassis 20 including the first frame rail 301 and the second frame rail 302, as described herein. In some embodiments, the chassis 20 includes a second lower frame rail configured as the second frame rail 302. The upper frame rail 321 and the lower frame rail 311 may be configured according to embodiments of the frame rails, as described herein.

The batteries 60 are positioned at least partially to the inside of (e.g., facing within the chassis 20) the lower frame rail 311 and the upper frame rail 321. The batteries 60 may be positioned within a pair of frame rails (e.g., a first lower frame rail and a second lower frame rail positioned opposite each other). The batteries 60 may extend a height into the lower frame rail 311 and/or the upper frame rail 321. The lower frame rail 311 may be positioned partially below the batteries 60 (e.g., a bottom of the lower frame rail 311 may be below the batteries 60). The upper frame rail 321 may be positioned partially above the batteries 60 (e.g., an upper surface of the upper frame rail 321 may be above the batteries 60). In some embodiments, the upper frame rail 321 may not be positioned above the batteries 60.

In some embodiments, the batteries 60 may be mounted to the lower frame rails (e.g., the lower frame rail 311). The batteries 60 may extend upwards and into a space between the upper frame rails. In some embodiments, the batteries 60 may be mounted to the upper frame rails (e.g., the upper frame rail 321). The batteries 60 may extend downwards into a space between the lower frame rails. In some embodiments, the batteries 60 may be mounted to both the lower frame rails and the upper frame rails.

The body actuator 182 is coupled to the upper frame rail 321. The body actuator 182 may be coupled to a side 322 of the upper frame rail 321. The body actuator 182 may be mounted to the upper frame rail 321 between the cab 40 and the batteries 60. The body actuator 182 may be mounted to the chassis 20 and/or the upper frame rail 321 using fasteners (e.g., bolts). The upper frame rail 321 may be used for mounting the body actuator 182 so that operation of the body actuator 182 to raise and/or lower the roll-off body 181 does not interfere with the batteries 60. In other word, the upper frame rail 321 provides clearance for the body actuator 182 to be mounted to the chassis 20 and operated for raising and/or lowering the roll-off body 181 to load or unload the electric roll-off vehicle 100.

In some embodiments, where the roll-off body assembly 180 includes the body actuator 182 and the second body actuator 382, the body actuator 182 may be mounted to the upper frame rail 321 (e.g., a first upper frame rail) and the second body actuator 382 may be mounted to a second upper frame rail. The chassis 20 may include the second upper frame rail positioned above and coupled to the second lower frame rail, where the frame rails are configured according to an embodiment of the frame rails as described herein. The body actuator 182 and the second body actuator 382 may be configured to operate in unison to raise and/or lower the roll-off body 181.

In some embodiments, the upper frame rail 321 includes a support member configured to space the roll-off body 181 apart from an upper surface of the upper frame rail 321. The support member is configured to position the roll-off body 181 above the batteries 60 (e.g., if a portion of the batteries 60 extends above the upper frame rail 321, to provide access to the batteries 60 from above the chassis 20, etc.).

In some embodiments, the various mounting arrangements for the body actuator 182 may change a profile (e.g., a height from the ground) of the electric roll-off vehicle 100. For example, the chassis 20 configured with the upper frame rail 321 may increase the height of the electric roll-off vehicle 100 compared to a height of the electric roll-off vehicle 100 where the chassis 20 only includes the lower frame rail 311, such as the first frame rail 301. For another example, the body actuator 182 mounted on the upper surface 303 of the first frame rail 301 may increase the height of the electric roll-off vehicle 100 compared to the height of the electric roll-off vehicle 100 where the body actuator 182 is coupled to the side 305 of the first frame rail 301 (e.g., because the upper surface 303 of the first frame rail 301 is positioned at a greater height from the ground than the side 305 of the first frame rail 301). In some embodiments, the various mounting arrangements for the body actuator 182 may change a height the roll-off body 181 is raised to by the body actuator 182. An angle that the roll-off body 181 may be raised and/or lowered to may also be changed based on the mounting arrangements of the body actuator 182 onto the chassis 20 of the electric roll-off vehicle 100. Other aspects (e.g., weight balance, length of the roll-off body, body actuator configuration) of the electric roll-off vehicle 100 may be modified corresponding to the body actuator 182 mounting for effective operation of the electric roll-off vehicle 100.

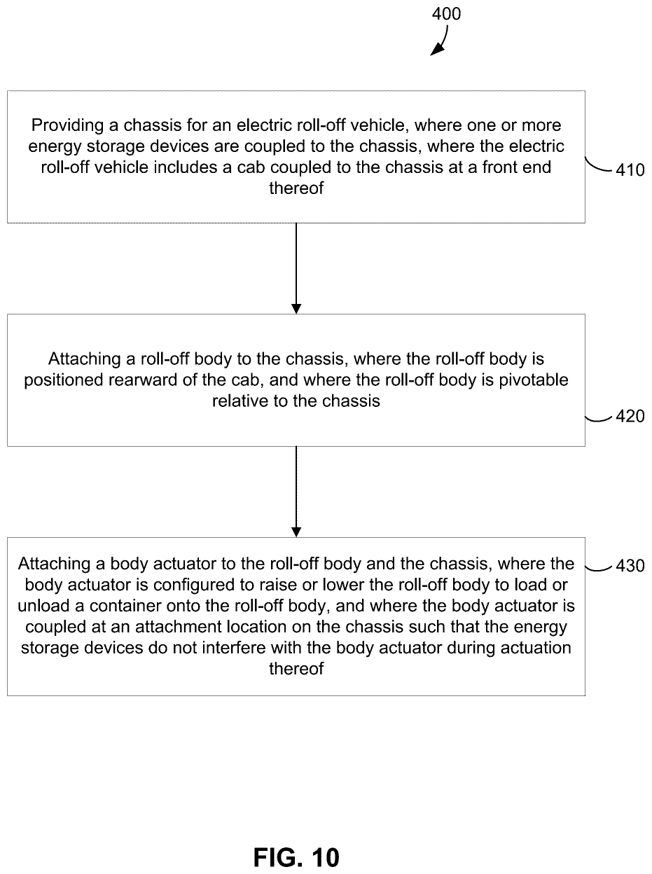

Referring to FIG. 10, a method 400 for assembling an electric roll-off vehicle is shown, according to an exemplary embodiment. For example, the method 400 may be completed (e.g., carried out, implemented, etc.) to assemble an embodiment of the electric roll-off vehicle 100, as described herein.

The method 400 may include providing a chassis for the electric roll-off vehicle, where one or more energy storage devices (e.g., batteries) are coupled (e.g., attached, connected, etc.) to the chassis, where the electric roll-off vehicle includes a cab coupled to the chassis at a front end thereof, at 410. For example, the method 400 may include attaching the one or more energy storage devices to the chassis. In some embodiments, the chassis with the one or more energy storage devices may be similar to the embodiment of the chassis 20, as described herein. In some embodiments, an electric drive motor may be coupled to the energy storage devices, such that the electric drive motor is configured to drive the electric roll-of vehicle (e.g., convert electrical energy into mechanical energy to move the wheels, etc.).

The method 400 may include attaching a roll-off body to the chassis, where the roll-off body is positioned rearward of the cab, and the roll-off body is pivotable relative to the chassis (e.g., to load or unload a container onto the roll-off body, etc.), at 420. For example, the roll-off body may be an embodiment of the roll-off body 181, as described herein.

The method 400 may include attaching a body actuator to the roll-off body and the chassis, where the body actuator is configured to raise or lower the roll-off body to load or unload a container onto the roll-off body, and where the body actuator is coupled at an attachment location on the chassis such that the energy storage devices do not interfere with the body actuator during actuation thereof, at 430. For example, the body actuator may be coupled to the chassis similarly to an embodiment of the body actuator 182 coupled to the chassis 20, as described herein. In some embodiments, the method 400 may include attaching the body actuator to an upper surface of the chassis. For example, the chassis may include at least one frame rail, where the body actuator is mounted on the upper surface of the at least one frame rail. In some embodiments, the method 400 may include attaching the body actuator to the chassis between the cab and the energy storage devices. For example, the body actuator may be mounted to a side surface of the at least one frame rail of the chassis. In some embodiments, the method 400 may include attaching the body actuator to an upper frame rail of the chassis. For example, the chassis may include a lower frame rail, and an upper frame rail coupled to and positioned above the lower frame rail. The body actuator may be mounted to a side portion (e.g., side surface) of the upper frame rail. For example, the lower frame rail may be positioned partially below the energy storage devices, with the upper frame rail positioned partially above the energy storage devices (e.g., such that the upper frame rail provides clearance between the body actuator and the energy storage devices when the body actuator is actuated, removing interference from the energy storage devices, etc.). In some embodiments, the body actuator may be mounted to the side portion of the upper frame rail between the cab and the energy storage device.

In some embodiments, the method 400 may include attaching other components of the electric roll-of vehicle to the chassis, such as a second body actuator, a winch assembly, a tarp cover assembly, etc., as described herein. In some embodiments, the method 400 may include additional, fewer, and/or a different order of method steps (e.g., operations).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the electric roll-off refuse vehicle and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An electric roll-off vehicle comprising:
a chassis extending a longitudinal length of the electric roll-off vehicle, the chassis comprising at least one frame rail;
a cab coupled to a front end of the chassis;
an electric energy storage device coupled to the chassis;
an electric drive motor coupled to the chassis and electrically connected to the electric energy storage device for driving the electric roll-off vehicle; and
a roll-off body assembly coupled to the chassis and positioned behind the cab, the roll-off body assembly comprising:
a roll-off body extending at least partially along the longitudinal length of the electric roll-off vehicle; and
a body actuator configured to raise a front end of the roll-off body, the body actuator powered by the electric energy storage device, wherein the body actuator is mounted to an upper surface of the at least one frame rail, and the electric energy storage device is positioned underneath the roll-off body and at least partially on a side of the at least one frame rail, such that the electric energy storage device does not interfere with the body actuator during operation thereof.

2. The electric roll-off vehicle of claim 1, wherein the at least one frame rail comprises a first frame rail comprising a first upper surface and a second frame rail comprising a second upper surface, wherein the body actuator is mounted to the first upper surface.

3. The electric roll-off vehicle of claim 2, wherein the body actuator is mounted to both the first upper surface and the second upper surface.

4. The electric roll-off vehicle of claim 2, wherein the roll-off body assembly further comprises a second body actuator configured to raise the front end of the roll-off body, the second body actuator mounted to the second upper surface of the second frame rail, and wherein the second body actuator is electrically coupled to the electric energy storage device.

5. The electric roll-off vehicle of claim 1, wherein the roll-off body assembly comprises an electric motor movably coupled to the body actuator, the electric motor electrically coupled to the electric energy storage device.

6. The electric roll-off vehicle of claim 1, wherein the roll-off body is pivotably coupled to the chassis at a pivot point proximate a rear end of the chassis, the body actuator configured to move the roll-off body assembly from a first position to a second position, wherein in the first position, the roll-off body is substantially parallel to the chassis, and wherein in the second position, the roll-off body is angled relative to the chassis, such that the front end of the roll-off body is raised.

7. The electric roll-off vehicle of claim 6, further comprising a winch assembly configured to pull a refuse container onto the roll-off body when the roll-off body assembly is in the second position.

8. The electric roll-off vehicle of claim 7, wherein the winch assembly comprises a winch motor and a cable engaged with the winch motor, wherein the winch motor is electrically coupled to the electric energy storage device.

9. An electric roll-off vehicle comprising:
a chassis extending a longitudinal length of the electric roll-off vehicle;
a cab coupled to a front end of the chassis;
an energy storage device coupled to the chassis;
an electric drive motor coupled to the chassis and electrically connected to the energy storage device for driving the electric roll-off vehicle; and
a roll-off body assembly coupled to the chassis and positioned behind the cab, the roll-off body assembly comprising:
a roll-off body extending at least partially along the longitudinal length of the electric roll-off vehicle; and
a body actuator configured to raise a front end of the roll-off body, wherein the body actuator is mounted to the chassis between the cab and the energy storage device, the body actuator powered by the energy storage device.

10. The electric roll-off vehicle of claim 9, wherein the chassis comprises at least one frame rail, wherein the body actuator is mounted to a side surface of the at least one frame rail.

11. The electric roll-off vehicle of claim 9, wherein the chassis comprises a first frame rail comprising a first side surface and a second frame rail comprising a second side surface, wherein the body actuator is mounted to the first side surface.

12. The electric roll-off vehicle of claim 11, wherein the roll-off body assembly further comprises a second body actuator configured to raise the front end of the roll-off body, the second body actuator mounted to the second side surface of the second frame rail, and the second body actuator powered by the energy storage device.

13. The electric roll-off vehicle of claim 9, wherein the roll-off body is pivotably coupled to the chassis at a pivot point proximate a rear end of the chassis, the body actuator configured to move the roll-off body assembly from a first position to a second position, wherein in the first position, the roll-off body is substantially parallel to the chassis, and wherein in the second position, the roll-off body is angled relative to the chassis, such that the front end of the roll-off body is raised.

14. The electric roll-off vehicle of claim 13, further comprising a winch assembly configured to pull a refuse container onto the roll-off body when the roll-off body assembly is in the second position, the winch assembly electrically coupled to the energy storage device.

15. An electric roll-off vehicle comprising:
a chassis supporting a plurality of tractive elements, the chassis comprising:
a lower frame rail; and
an upper frame rail coupled to and positioned above the lower frame rail;
a cab coupled to a front end of the chassis;
an energy storage device coupled to the chassis, wherein the energy storage device extends between the upper frame rail and the lower frame rail;
an electric drive motor coupled to the chassis and electrically connected to the energy storage device for powering movement of the tractive elements; and
a roll-off body assembly coupled to the upper frame rail of the chassis and positioned behind the cab and above the energy storage device, the roll-off body assembly comprising:
a roll-off body extending at least partially along a longitudinal length of the chassis; and
a body actuator configured to raise a front end of the roll-off body, wherein the body actuator is mounted to the upper frame rail, and wherein the body actuator is powered by the energy storage device.

16. The electric roll-off vehicle of claim 15, wherein the lower frame rail is positioned partially below the energy storage device and the upper frame rail is positioned partially above the energy storage device.

17. The electric roll-off vehicle of claim 15, wherein the body actuator is mounted to a side portion of the upper frame rail.

18. The electric roll-off vehicle of claim 17, wherein the body actuator is mounted to the side portion of the upper frame rail between the cab and the energy storage device.

19. The electric roll-off vehicle of claim 15, wherein the upper frame rail is a first upper frame rail, and the lower frame rail is a first lower frame rail, the chassis further comprising:
a second lower frame rail; and
a second upper frame rail coupled to and positioned above the second lower frame rail;
wherein the roll-off body assembly further comprises a second body actuator configured to raise the front end of the roll-off body, the second body actuator mounted on the second upper frame rail, and the second body actuator powered by the energy storage device.

20. The electric roll-off vehicle of claim 15, wherein the chassis further includes a support member coupled to the upper frame rail and configured to position the roll-off body assembly above the energy storage device.
